(19) United States
(12) Patent Application Publication
(10) Pub. No.: US 2010/0276938 A1
(43) Pub. Date: Nov. 4, 2010

(54) AEROGENERATOR

(76) Inventor: Edward Victor Smith, Aloha, OR (US)

Correspondence Address: SHERR & VAUGHN, PLLC, 620 HERNDON PARKWAY, SUITE 320, HERNDON, VA, 20170, US

(21) Appl. No.: 12/434,337

(22) Filed: May 1, 2009

(51) Int. Cl. F03D 9/02

(52) U.S. Cl. 290/55

(57) ABSTRACT

Disclosed herein is an aerogenerator. The aerogenerator includes an impeller which is rotated by wind. A conversion unit mounts the impeller to a support structure so that the impeller can rotate, and converts the rotating motion of the impeller into linear motion. At least one rod is reciprocated linearly by the conversion unit. A magnet is provided on the rod and has magnetic force. An induction coil is provided outside the reciprocating magnet, and interacts with the magnet to create an induced voltage. A transform unit transforms the induced voltage of the induction coil to an electric current. An electricity storage unit stores the electric current of the transform unit.

### BACKGROUND OF THE INVENTION

1. Field of the Invention

The present invention relates generally to aerogenerators and, more particularly, to an aerogenerator which converts the wind-induced rotary motion of an impeller into a linear reciprocating motion, changes induced voltage generated between a magnet and an induction coil by the linear reciprocating motion into an electric current and stores the electric current, thus generating a large amount of electricity as in a conventional aerogenerator, while reducing manufacturing cost and maintenance cost.

2. Description of the Related Art

Generally, an aerogenerator is a generator which rotates a rotary impeller using naturally occurring wind to obtain rotary force and converts the rotary force into electric energy, thus supplying the electricity to a region requiring the electricity.

Such an aerogenerator includes a support shaft, a rotary body and a rotary impeller. The support shaft is placed on the ground to be supported in a vertical direction.

Further, the rotary body is provided on the upper end of the support shaft in such a way as to rotate freely. The rotary impeller is provided on the rotary body, thus generating rotary force by wind.

In such an aerogenerator, the rotary body is rotated such that the rotary impeller points in the direction of the wind. Thereby, the rotary impeller is easily rotated by the wind.

FIG. 1 is a view illustrating a conventional aerogenerator.

As shown in the drawing, the aerogenerator 1 includes a support shaft 10 which is set up on the ground, and a rotary body 20 which is rotatably provided on the upper end of the support shaft 10. A rotary impeller 30 is rotatably provided on the rotary body 20.

Further, a generator 40 and a rotating-force conversion unit 50 are provided in the rotary body 20. The rotating-force conversion unit 50 includes a plurality of gears to increase the rotary force of the rotary impeller 30 and transmit the increased rotary force to the generator 40.

Since the aerogenerator must generate the maximum amount of electricity per transmitted rotary force, a large capacity generator 40 is used.

However, the large capacity generator 40 is expensive, thus increasing manufacturing cost and maintenance cost.

Especially, since the heavy and large capacity generator 40 is provided in the rotary body 20, the rotary body 20 cannot easily rotate in the direction of the wind because of the weight of the generator 40. As a result, the efficiency of the aerogenerator is lowered.

Further, a rotating shaft is bent downwards due to the large capacity generator 40, thus causing the disengagement of the gears of the rotating-force conversion unit 50. In this case, the rotating-force conversion unit 50 is frequently out of order, so that the rotary force is reduced and thus efficiency is lowered.

The problems occur even in a dual rotor as well as in a single rotor.

Therefore, in order to prevent the bending of the rotating shaft and to reduce manufacturing cost and maintenance cost, there is an urgent need for an aerogenerator which uses an inexpensive small capacity generator but is capable of generating the same amount of electricity as when using a large capacity generator, by the introduction of a good idea.

### SUMMARY OF THE INVENTION

Accordingly, the present invention has been made keeping in mind the above problems occurring in the prior art, and an object of the present invention is to provide an aerogenerator, in which wind-induced rotary motion is converted into linear reciprocating motion, so that a linearly reciprocated magnet passes through an induction coil, thus generating electricity.

Another object of the present invention is to provide an aerogenerator having a rotating shaft which is bent several times to form a plurality of horizontal parts each having a central axis parallel to a rotating central axis, each horizontal part being rotated while its central axis follows an arc along a predetermined rotating radius from the rotating central axis, thus linearly reciprocating each of a plurality of links connected to the horizontal part.

A further object of the present invention is to provide an aerogenerator, in which a magnet and an induction coil are provided on an end of each of a plurality of links to generate electricity, thus reducing manufacturing cost, in addition to generating a large amount of electricity.

Yet another object of the present invention is to provide an aerogenerator, in which horizontal parts are spaced apart from the central axis of a rotating shaft by a predetermined distance, and the horizontal parts have two or more orientations relative to the central axis of the rotating shaft, thus allowing more links, magnets and induction coils to be provided, therefore increasing output.

A still further object of the present invention is to provide an aerogenerator, in which an end of a link branches out to form a plurality of branches which are parallel in the linear moving direction, and a magnet and an induction coil are provided on the end of each branch, thus further increasing output.

In order to accomplish the above objects, the present invention provides an aerogenerator, including an impeller rotated by wind, a conversion unit which mounts the impeller to a support structure so that the impeller can rotate and converts the rotating motion of the impeller into linear motion, at least one rod reciprocated linearly by the conversion unit, a magnet provided on the rod and having magnetic force, an induction coil provided outside the reciprocating magnet and interacting with the magnet to create an induced voltage, a transform unit for transforming the induced voltage of the induction coil to an electric current, and an electricity storage unit for storing the electric current of the transform unit.

The conversion unit may include a rotating shaft which is bent several times to create a plurality of horizontal parts each having a central axis parallel to a rotating central axis, and is rotated while the central axis of the horizontal part forms a circle of a predetermined rotating radius from the rotating central axis, and a link. The first end of the link is rotatably provided on each of the horizontal parts of the rotating shaft so that the link rotates in conjunction with a rotation of the horizontal part, and the second end of the link is connected to the rod so that the link is moved along an extrapolated line coupling a central axis of the rotating shaft with a central axis of the induction coil.

Further, the conversion unit may include a rotating shaft having a plurality of cams along the rotating central axis, each of the cams being formed such that distances from a rotating central point to respective portions on an edge gradually vary, and a pressure member reciprocated linearly by a contact of an end of the rod with an outer circumference of each of the cams, exerting elasticity in a moving direction of the rod, and pressing the rod towards each of the cams.

Further, a roller may be further provided on the end of the rod so as to reduce frictional force between the rod and the outer circumference of each of the cams.

A plurality of rods, magnets and induction coils may be provided along the rotating central axis in rows, the rows of the rods, magnets and induction coils being positioned in one or more directions relative to a rotating central point of the conversion unit.

Two or more magnets and induction coils may be provided on the rod.

An end of the rod may branch out into at least two branches in such a way as to be parallel to a linear motion direction, each of the branches having on an end thereof the magnet and the induction coil.

Further, a guide may be provided outside the rod to guide a linear reciprocating motion.

A gearbox may be provided between the impeller and the conversion unit to change the rotating speed of the impeller.

The aerogenerator may further include an auxiliary impeller provided on a side opposite to the support structure to which the impeller is mounted, an auxiliary conversion unit which mounts the auxiliary impeller to a support structure so that the auxiliary impeller can rotate and converts the rotating motion of the auxiliary impeller into linear motion, at least one auxiliary rod reciprocated linearly by the auxiliary conversion unit, an auxiliary magnet provided on the auxiliary rod and having magnetic force, an auxiliary induction coil provided outside the reciprocating auxiliary magnet and interacting with the auxiliary magnet to create an induced voltage, an auxiliary transform unit for transforming the induced voltage of the auxiliary induction coil to an electric current, and an auxiliary electricity storage unit for storing the electric current of the auxiliary transform unit.

Further, the auxiliary impeller may be placed on the same axis as the rotating central axis of the impeller, a radius of an arc formed by the rotating auxiliary impeller being equal to 35 to 45% of a radius of a rotating arc formed by the impeller.

Further, the auxiliary conversion unit may include an auxiliary rotating shaft bent several times to create a plurality of horizontal parts each having a central axis parallel to a rotating central axis, the rotating shaft being rotated while the central axis of the horizontal part forms a circle of a predetermined rotating radius from the rotating central axis, and an auxiliary link, a first end of the auxiliary link being rotatably provided on each of the horizontal parts of the auxiliary rotating shaft so that the auxiliary link rotates in conjunction with a rotation of the horizontal part, a second end of the auxiliary link being connected to the auxiliary rod so that the auxiliary link is moved along an extrapolated line coupling a central axis of the auxiliary rotating shaft with a central axis of the auxiliary induction coil.

The auxiliary conversion unit may include an auxiliary rotating shaft having a plurality of auxiliary cams along the rotating central axis, each of the auxiliary cams being formed such that distances from a rotating central point to respective portions on an edge gradually vary, and an auxiliary pressure member reciprocated linearly by a contact of an end of the auxiliary rod with an outer circumference of each of the auxiliary cams, exerting elasticity in a moving direction of the auxiliary rod, and pressing the auxiliary rod towards each of the auxiliary cams.

Further, an auxiliary gearbox may be provided between the auxiliary impeller and the auxiliary conversion unit to change the rotating speed of the auxiliary impeller.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a conventional aerogenerator;

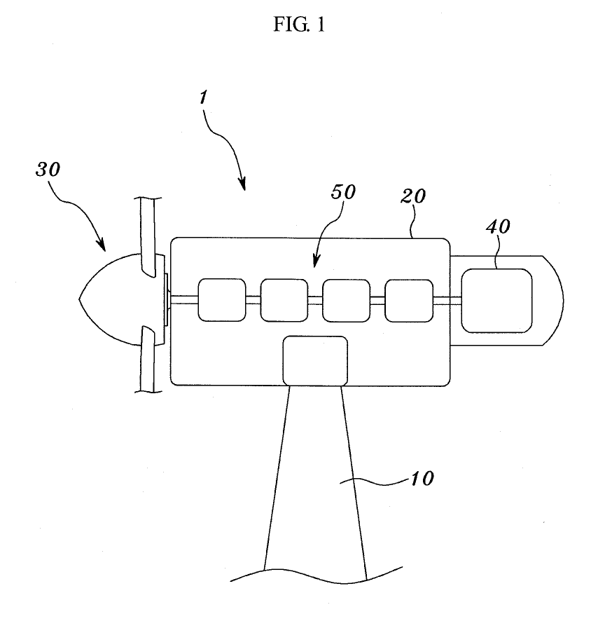

FIG. 2 is a view illustrating an aerogenerator according to an embodiment of the present invention;

FIG. 3 is a front view illustrating the aerogenerator according to the present invention;

FIG. 4 is a perspective view illustrating a conversion unit of the aerogenerator according to the present invention;

FIG. 5 is a view illustrating the operation of the aerogenerator according to the present invention;

FIG. 6 is a view illustrating a rotating shaft and links of an aerogenerator according to another embodiment of the present invention;

FIG. 7 is a perspective view illustrating the rotating shaft and the links of FIG. 6;

FIG. 8 is a view illustrating another arrangement of rods of the aerogenerator according to the present invention;

FIG. 9 is a view illustrating magnets and induction coils of an aerogenerator according to a further embodiment the present invention;

FIG. 10 is a view illustrating another arrangement of a rod, magnets and induction coils of the aerogenerator according to the present invention;

FIG. 11 is a view illustrating a conversion unit of an aerogenerator according to another embodiment of the present invention;

FIG. 12 is a front view illustrating the conversion unit of the aerogenerator according to the present invention;

FIG. 13 is a view illustrating the operation of the conversion unit of the aerogenerator according to the present invention;

FIG. 14 is a view illustrating another arrangement of rods applied to the conversion unit of FIG. 11;

FIG. 15 is a view illustrating an aerogenerator which further has an auxiliary aerogenerator according to another embodiment of the present invention;

FIG. 16 is a view illustrating another embodiment of an auxiliary conversion unit applied to the auxiliary aerogenerator of FIG. 15.

### DESCRIPTION OF THE PREFERRED EMBODIMENTS

Hereinafter, the preferred embodiments of the present invention will be described with reference to the accompanying drawings.

Further, it is to be understood that the invention is not limited in its application to the embodiments and that various changes and modifications may be made in the invention without departing from the spirit and scope of the invention.

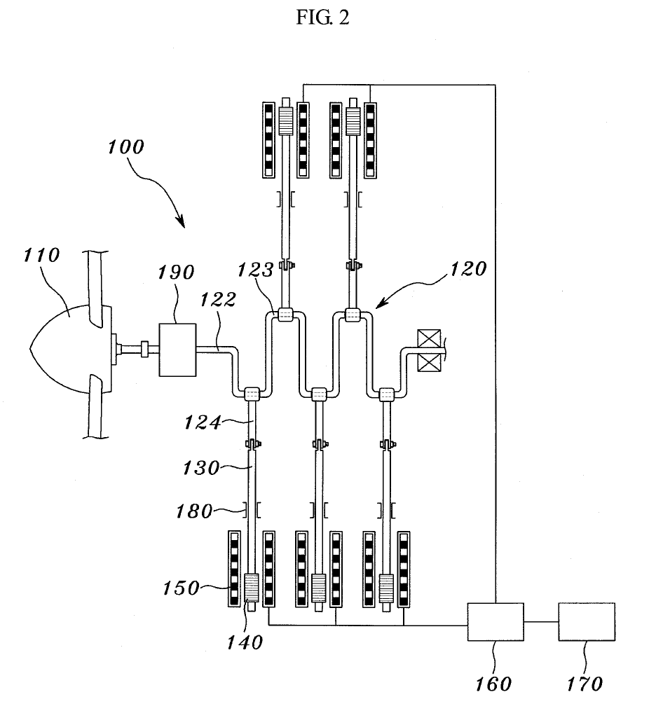

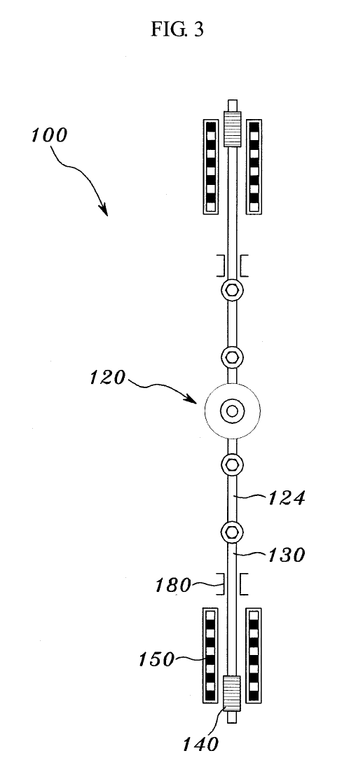

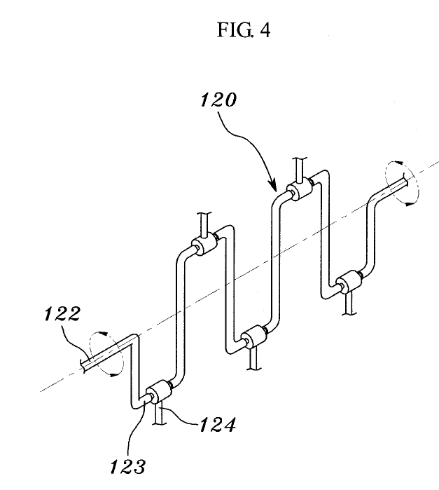

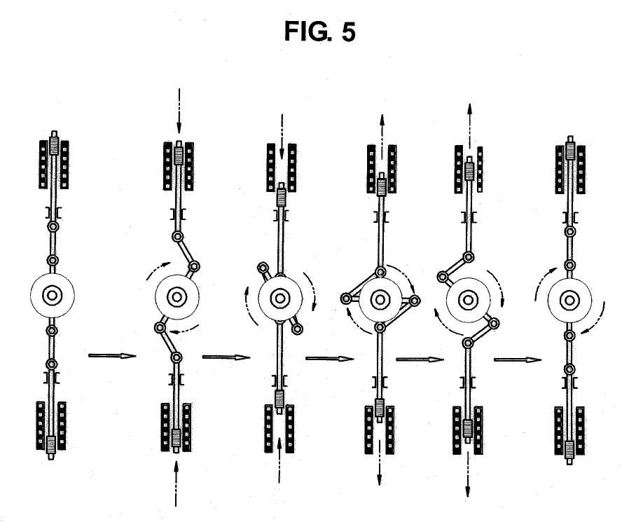

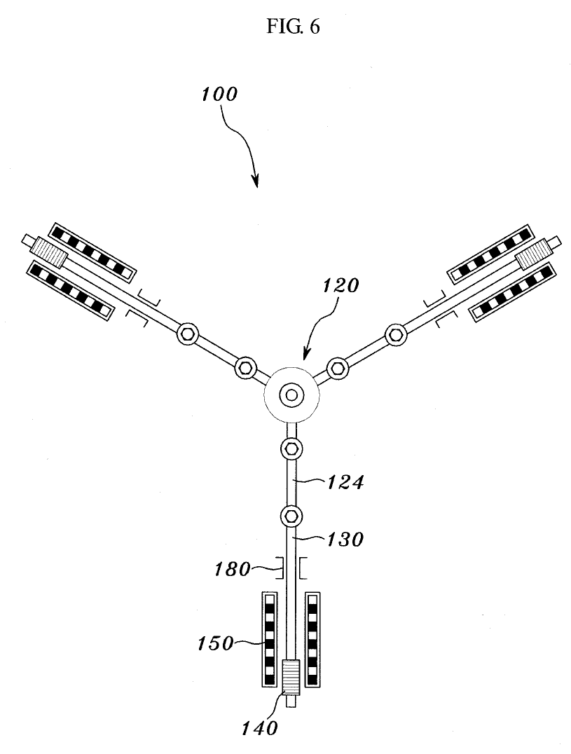

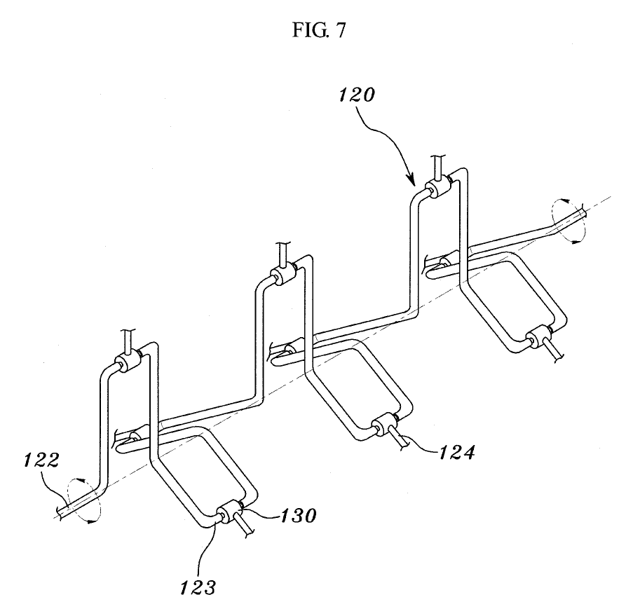

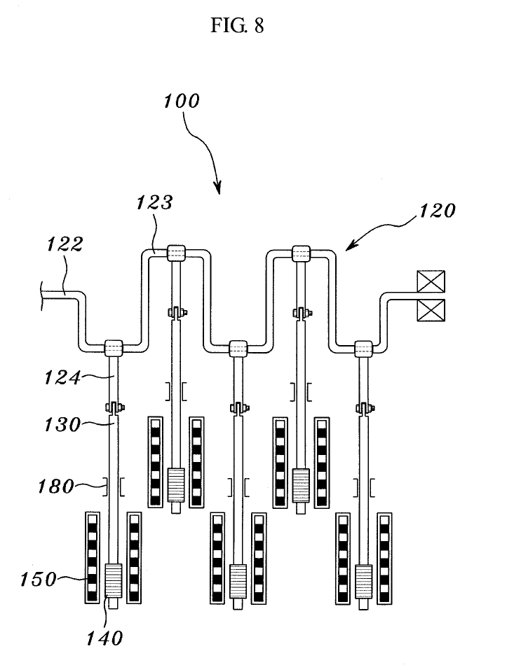

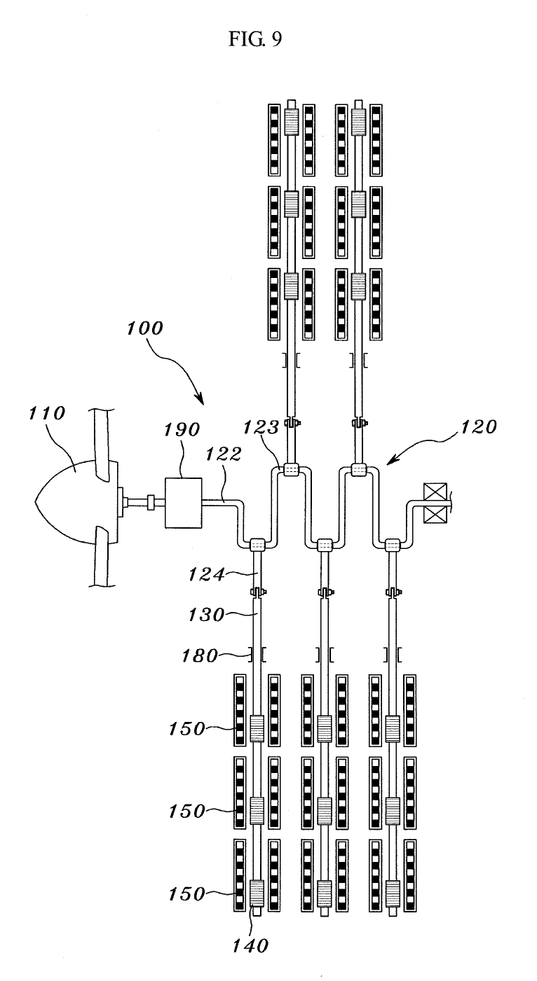

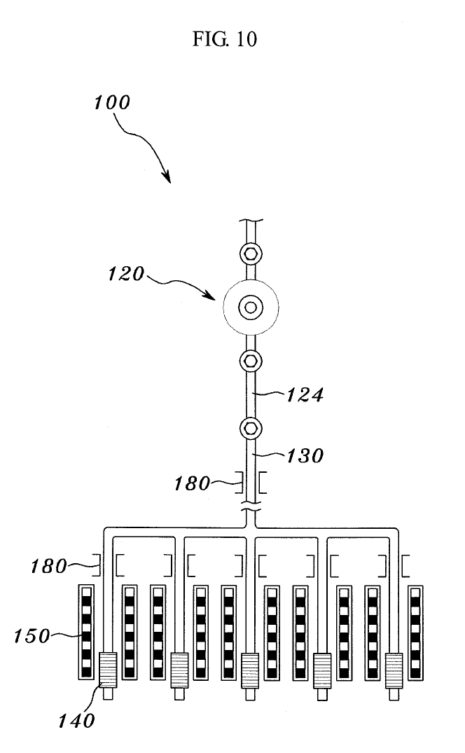

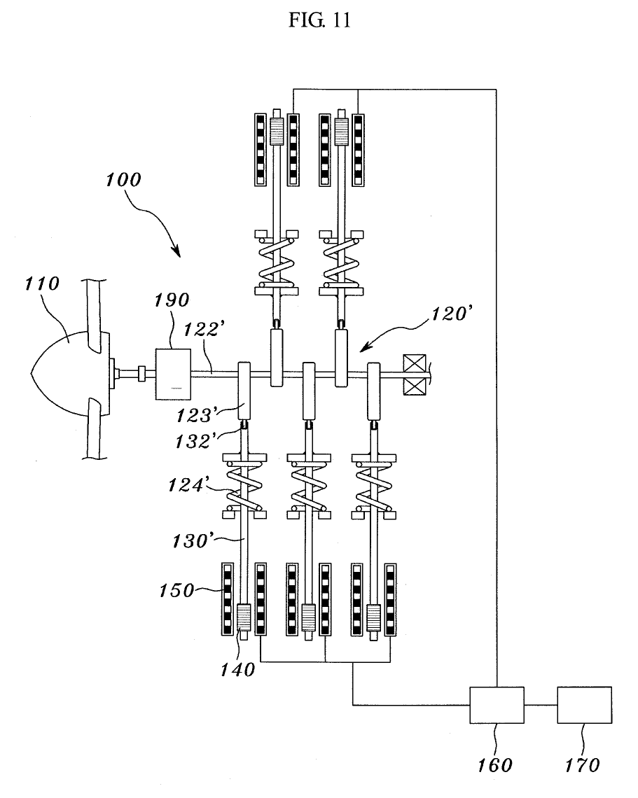

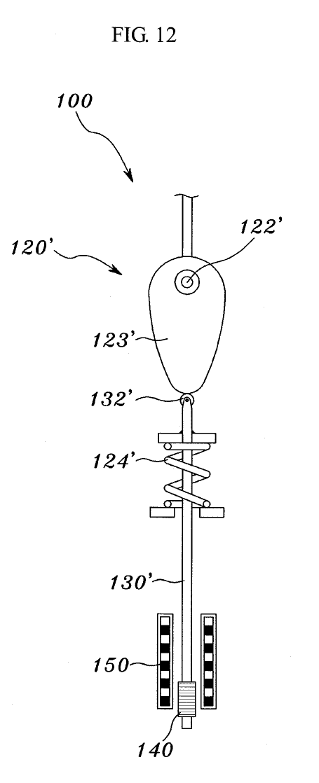

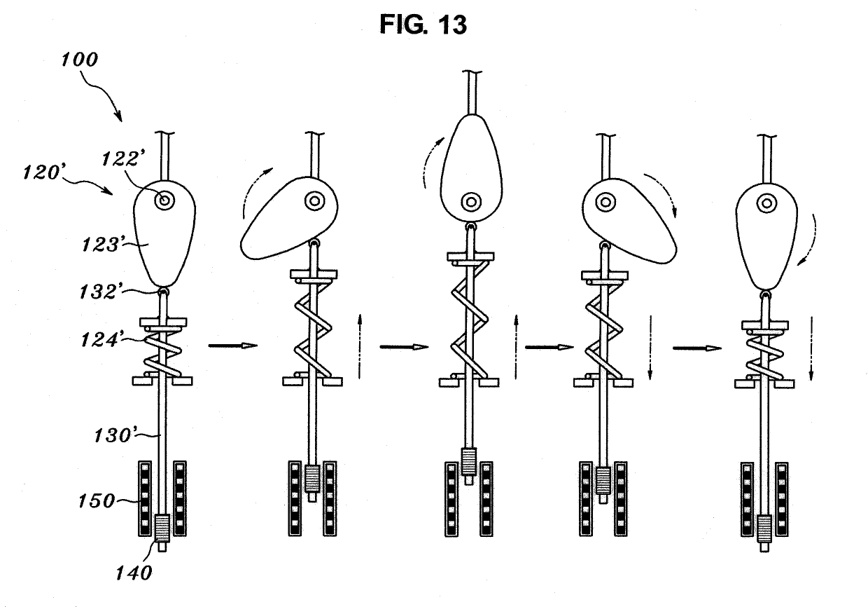

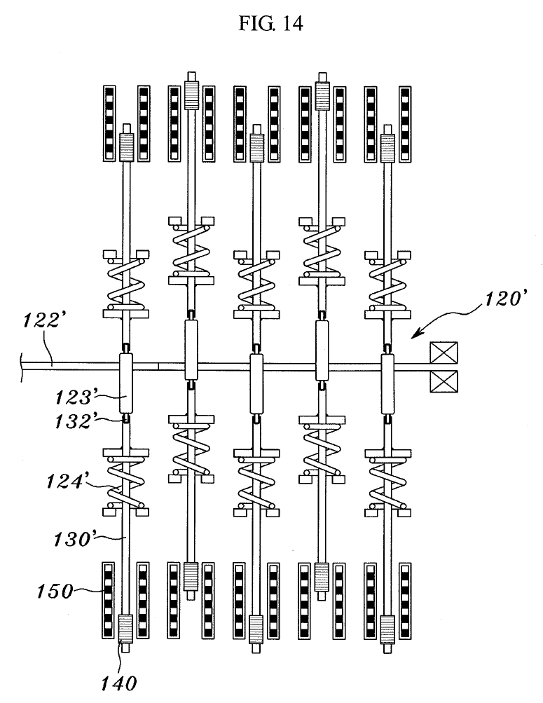

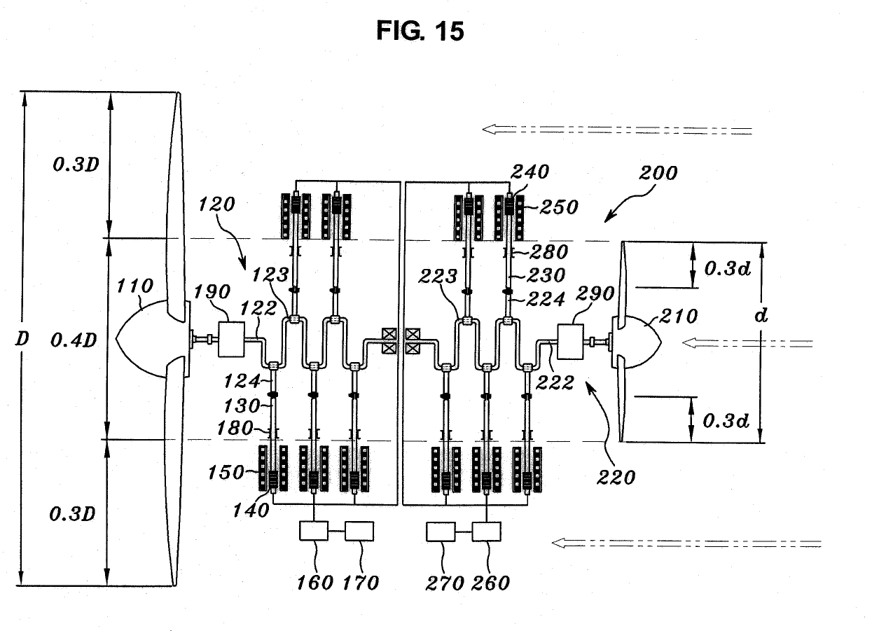

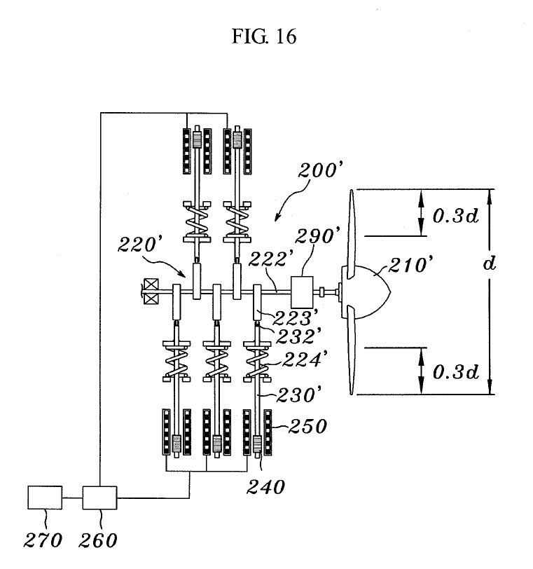

FIG. 2 is a view illustrating an aerogenerator according to an embodiment of the present invention, FIG. 3 is a front view illustrating the aerogenerator according to the present invention, FIG. 4 is a perspective view illustrating a conversion unit of the aerogenerator according to the present invention, FIG. 5 is a view illustrating the operation of the aerogenerator according to the present invention, FIG. 6 is a view illustrating a rotating shaft and links of an aerogenerator according to another embodiment of the present invention, FIG. 7 is a perspective view illustrating the rotating shaft and the links of FIG. 6, FIG. 8 is a view illustrating another arrangement of rods of the aerogenerator according to the present invention, FIG. 9 is a view illustrating magnets and induction coils of an aerogenerator according to a further embodiment the present invention, FIG. 10 is a view illustrating another arrangement of a rod, magnets and induction coils of the aerogenerator according to the present invention, FIG. 11 is a view illustrating a conversion unit of an aerogenerator according to another embodiment of the present invention, FIG. 12 is a front view illustrating the conversion unit of the aerogenerator according to the present invention, FIG. 13 is a view illustrating the operation of the conversion unit of the aerogenerator according to the present invention, FIG. 14 is a view illustrating another arrangement of rods applied to the conversion unit of FIG. 11, FIG. 15 is a view illustrating an aerogenerator which further has an auxiliary aerogenerator according to another embodiment of the present invention, FIG. 16 is a view illustrating another embodiment of an auxiliary conversion unit applied to the auxiliary aerogenerator of FIG. 15.

As shown in the drawings, the aerogenerator 100 includes an impeller 110, a conversion unit 120, a rod 130, a magnet 140, an induction coil 150, a transform unit 160 and an electricity storage unit 170.

The impeller 110 is rotated by wind. The impeller 110 is rotatably installed to a support structure (not shown) via the conversion unit 120.

Here, the conversion unit 120 functions to convert rotary motion into linear motion. That is, the conversion unit 120 converts the wind-induced rotary motion of the impeller 110 into linear motion.

Further, the aerogenerator is provided with at least one rod 130 which is linearly reciprocated by the conversion unit 120. A plurality of rods 130 may be provided along the rotating central axis of the conversion unit 120.

Each rod 130 is provided with a magnet 140. The magnet 140 has magnetic force, and reciprocates linearly along the corresponding rod 130 which is reciprocated linearly.

Further, the induction coil 150 is provided outside the linearly reciprocating magnet 140, and interacts with the magnet 140 to generate induced voltage.

The transform unit 160 transforms the induced voltage generated in the induction coil 150 into an electric current, and the electricity storage unit 170 stores the electric current.

In this case, the aerogenerator is provided with one transform unit 160 and one electricity storage unit 170 to collect voltage transmitted from the respective induction coils 150 and accumulate the voltage in the form of electricity. If necessary, the transform unit 160 and the electricity storage unit 170 may be provided on each induction coil 150.

Further, the conversion unit 120 includes a rotating shaft 122 and links 124. The rotating shaft 122 is bent several times to create a plurality of horizontal parts 123 each having a central axis which is parallel to a rotating central axis. The horizontal parts 123 are rotated while the central axis of each horizontal part 123 forms a circle of a predetermined rotating radius from the rotating central axis.

Each link 124 is rotatably connected at one end thereof to the associated horizontal part 123 of the rotating shaft 122, so that the link 124 is rotated by the rotation of the horizontal part 123. The other end of each link 124 is connected to the associated rod 130, so that the link 124 moves along an extrapolated line coupling the central axis of the rotating shaft 122 to the central axis of the induction coil 150.

In other words, as each horizontal part 122 is rotated and forms a circle of a predetermined rotating radius by the rotation of the impeller 110, one end of the associated link 124 is rotated and the other end is linearly reciprocated, thus linearly reciprocating the rod 130.

That is, the rotating shaft 122 of the conversion unit 120 has the structure of a crank shaft.

The linear reciprocating motion of each rod 130 may continuously generate induced voltage as each magnet 140 reciprocates relative to and passes through the induction coil 150. The induced voltage passes through the transform unit 160, and thereafter is accumulated in the electricity storage unit 170.

The plurality of rods 130, magnets 140 and induction coils 150 are provided along the rotating central axis in rows. The rows of the rods 130, magnets 140 and induction coils 150 are positioned in one or more radial directions relative to the rotating central point of the conversion unit 120.

In other words, as shown in FIGS. 2 through 5, the rotating shaft 122 of the conversion unit 120 is alternately bent in opposing directions relative to the rotating central axis, thus forming a plurality of horizontal parts 123. Each link 124 is rotatably provided on the associated horizontal part 123.

The operation of the aerogenerator by the rotation of the rotating shaft 122 which repetitively has the horizontal parts 123 arranged in opposing directions is shown in FIG. 5. As the impeller 110 is rotated by wind, the rotating shaft 122 of the conversion unit 120 is rotated. As a result, a plurality of horizontal parts 123 rotates while each forming a circle of a predetermined rotating radius.

As the link 124 connected to each horizontal part 123 is rotated so as to linearly reciprocate the rod 130, the magnet 140 is also reciprocated linearly.

Preferably, a guide 180 is further provided outside each rod 130 to guide the linear reciprocating motion of the rod 130, thus preventing the magnet 140 and the induction coil 150 from colliding with each other.

Further, as shown in FIGS. 6 and 7, the rotating shaft 122 of the conversion unit 120 is bent in three directions with respect to the rotating central axis, thus forming a plurality of horizontal parts 123. A link 124 is rotatably provided on each horizontal part 123.

Such a construction ensures a predetermined interval between each magnet 140 and induction coil 150 and neighboring magnet and induction coil, and provides a stable triangular arrangement, thus preventing the rotating shaft 120 from being bent to one side or twisted during its rotation, therefore increasing the lifespan of the rotating shaft 120.

Further, as shown in FIG. 8, the rotating shaft 122 of the conversion unit 120 is bent in one or more directions with respect to the rotating central axis, thus forming a plurality of horizontal parts 123. However, links 124, rods 130, magnets 140 and induction coils 150 provided on respective horizontal parts 123 are oriented in one direction.

In detail, the rods 130 are parallel to each other and the magnets 140 are provided on the rods 130 in such a way as to be located at upper and lower positions in a vertical direction, thus reducing the effect of gravity, therefore preventing the rods 130 from being bent downwards.

Meanwhile, two or more magnets 140 and induction coils 150 may be provided on each rod 130. As shown in FIG. 9, a plurality of magnets 140 may be provided on each rod 130 at regular intervals, and induction coils 150 may be provided to correspond to the magnets 140.

Such a construction increases the voltage generated by a single rotation. The number of magnets and induction coils is not limited to a specific number.

Further, as shown in FIG. 10, an end of each rod 130 branches out into two or more branches. Each branch is provided with the magnet 140 and the induction coil 150 so as to increase the output of voltage.

Preferably, each branch of the rod 130 is parallel to the direction of the linear reciprocating motion, and is provided with a guide 180.

Further, a gearbox 190 is provided between the impeller 110 and the conversion unit 120, and changes the rotating speed of the impeller 110, thus increasing a rotating speed transmitted to the conversion unit 120.

Through such a construction, when the impeller 110 rotates once, the conversion unit 120 is rotated one or more times, so that the linear reciprocating motion of the rods 130 is increased, and the amount of induced voltage which is generated is increased.

Meanwhile, FIGS. 11 through 14 illustrate a conversion unit 120′ according to another embodiment of the present invention. The conversion unit 120′ includes a rotating shaft 122′ and a pressure member 124′.

The rotating shaft 122′ is provided with a plurality of cams 123′ along a rotating central axis. Each cam 123′ is formed such that distances from a rotating central point to respective portions on an edge gradually vary.

The pressure member 124′ presses a rod 130′ towards each cam 123′. As the rod 130′ reciprocates linearly while an end of the rod 130′ contacts the outer circumference of each cam 123′, induced voltage is generated between the magnet 140 and the induction coil 150.

The plurality of cams 123′ may be provided on the rotating shaft 122′ in such a way that the longest portions from edges of the cams 123′ to the rotating central point are alternately placed at upper and lower positions, are placed in three directions in a triangular shape, or are placed in the same direction. As such, the cams 123′ may be positioned regardless of direction.

However, the cams 123′ must be positioned such that the rotating shaft 122′ of the conversion unit 120′ is not bent when the impeller 110 rotates.

Further, one or more rods 130′ may contact one cam 123′. As shown in FIG. 14, as one or more rods 130′ reciprocate linearly as a result of a single rotation, the amount of induced voltage which is generated is increased.

Here, a roller 132′ is further provided on an end of each rod 130′ to reduce frictional force between the rod 130′ and the outer circumference of the cam 123′, thus allowing the rod 130′ to easily reciprocate linearly along the outer circumference of the cam 123′.

The conversion unit 120′ may substitute for the conversion unit 120. All embodiments applied to the conversion unit 120 which are shown in FIGS. 3 and 4 and FIGS. 6 to 10 and have been described hereinbefore may be applied to the conversion unit 120′.

Further, as shown in FIG. 15, an auxiliary aerogenerator 200 may be further provided on a side opposite to the impeller 110 of the aerogenerator 100. The auxiliary aerogenerator 200 includes an auxiliary impeller 210, an auxiliary conversion unit 220, an auxiliary rod 230, an auxiliary magnet 240, an auxiliary induction coil 250, an auxiliary transform unit 260 and an auxiliary electricity storage unit 270.

The auxiliary impeller 210 is provided on a side opposite to a support structure to which the impeller 110 is mounted, and is rotatably installed to a support structure (not shown) via the auxiliary conversion unit 220.

The auxiliary conversion unit 220 functions to convert rotary motion into linear motion. That is, the auxiliary conversion unit 220 converts the wind-induced rotary motion of the auxiliary impeller 210 into linear reciprocating motion.

Further, the aerogenerator is provided with at least one auxiliary rod 230 which is linearly reciprocated by the auxiliary conversion unit 220. A plurality of auxiliary rods 230 may be provided along the rotating central axis of the auxiliary conversion unit 220.

Each auxiliary rod 230 is provided with an auxiliary magnet 240. The auxiliary magnet 240 has magnetic force, and reciprocates linearly along the corresponding auxiliary rod 230 which is reciprocated linearly.

Further, the auxiliary induction coil 250 is provided outside the linearly reciprocating auxiliary magnet 240, and interacts with the auxiliary magnet 240 to generate induced voltage.

The auxiliary transform unit 260 transforms the induced voltage generated in the auxiliary induction coil 250 into an electric current, and the auxiliary electricity storage unit 270 stores the electric current.

In this case, the aerogenerator is provided with one auxiliary transform unit 260 and one auxiliary electricity storage unit 270 to collect voltage transmitted from the respective auxiliary induction coils 250 and accumulate the voltage in the form of electricity. If necessary, the auxiliary transform unit 260 and the auxiliary electricity storage unit 270 may be provided on each auxiliary induction coil 250.

Further, induced voltage generated in each auxiliary induction coil 250 may pass through the transform unit 160 and accumulate in the electricity storage unit 170.

Further, the auxiliary conversion unit 220 is operated identically to the conversion unit 120 or 120′ of FIGS. 2 through 14. All embodiments of the conversion unit 120 or 120′ may be applied to the auxiliary conversion unit 220.

For example, reference numeral 280 of FIG. 15 denotes a guide which functions to guide the linear reciprocating motion of each auxiliary rod 230.

Further, the auxiliary impeller 210 is placed on the same axis as the rotating central axis of the impeller 110. The radius formed by the rotating auxiliary impeller 210 is 35 to 45% of the radius of the rotating impeller.

Now, the rotation of the impeller 110 in the aerogenerator 100 will be described. In order for the impeller 110 to be rotated by wind, a portion extending from each end of the impeller 110 by 30% of the diameter D of the impeller 110 is used. The portion corresponding to 30% of the diameter D of the impeller 110 may be designated as 0.3 D.

This means that wind acting on the central portion of the impeller 110 having the length of 0.4 D, excluding a portion extending from each of the opposite ends of the impeller 110 by the length of 0.3 D, is not used. Thereby, the auxiliary impeller 210 having a diameter d which is equal to the diameter 0.4 D of the central portion of the impeller 110 is provided such that the auxiliary impeller 210 is rotated by wind passing through the central portion of the impeller 110 having the diameter of 0.4 D.

Preferably, the auxiliary impeller 210 is positioned to be pointed in the direction in which the wind is blowing.

Further, the auxiliary conversion unit 220 includes an auxiliary rotating shaft 222 and auxiliary links 224. The auxiliary rotating shaft 222 is bent several times to create a plurality of horizontal parts 223 each having a central axis which is parallel to a rotating central axis. The horizontal parts 223 are rotated while the central axis of each horizontal part 223 forms a circle of a predetermined rotating radius from the rotating central axis.

Each auxiliary link 224 is rotatably connected at one end thereof to the associated horizontal part 223 of the auxiliary rotating shaft 222, so that the auxiliary link 224 is rotated by the rotation of the horizontal part 223. The other end of each auxiliary link 224 is connected to the associated auxiliary rod 230, so that the auxiliary link 224 moves along an extrapolated line coupling the central axis of the auxiliary rotating shaft 222 to the central axis of the auxiliary induction coil 250.

In other words, as each horizontal part 223 is rotated and forms a circle of a predetermined rotating radius by the rotation of the auxiliary impeller 210, one end of the associated auxiliary link 224 is rotated and the other end is linearly reciprocated, thus linearly reciprocating the auxiliary rod 230.

That is, the auxiliary rotating shaft 222 of the auxiliary conversion unit 220 has the structure of a crank shaft.

The linear reciprocating motion of each auxiliary rod 230 may continuously generate induced voltage as each auxiliary magnet 240 reciprocates relative to and passes through the auxiliary induction coil 250. The induced voltage passes through the auxiliary transform unit 260, and thereafter is accumulated in the auxiliary electricity storage unit 270.

The plurality of auxiliary rods 230, auxiliary magnets 240 and auxiliary induction coils 250 are provided along the rotating central axis in rows. The rows of the auxiliary rods 230, auxiliary magnets 240 and auxiliary induction coils 250 are positioned in one or more radial directions relative to the rotating central point of the auxiliary conversion unit 220.

In other words, the auxiliary rotating shaft 222 of the auxiliary conversion unit 220 is alternately bent in opposing directions relative to the rotating central axis, thus forming a plurality of horizontal parts 223. Each auxiliary link 224 is rotatably provided on the associated horizontal part 223.

The operation of the aerogenerator by the rotation of the auxiliary rotating shaft 222 which repetitively has the horizontal parts 223 arranged in opposing directions is as follows. As the auxiliary impeller 210 is rotated by wind, the auxiliary rotating shaft 222 of the auxiliary conversion unit 220 is rotated. As a result, a plurality of horizontal parts 223 rotates while each forming a circle of a predetermined rotating radius.

As the auxiliary link 224 connected to each horizontal part 223 is rotated so as to linearly reciprocate the auxiliary rod 230, the auxiliary magnet 240 is also reciprocated linearly.

Preferably, a guide 280 is further provided outside each auxiliary rod 230 to guide the linear reciprocating motion of the auxiliary rod 230, thus preventing the auxiliary magnet 240 and the auxiliary induction coil 250 from colliding with each other.

Further, the auxiliary rotating shaft 222 of the auxiliary conversion unit 220 is bent in three directions with respect to the rotating central axis, thus forming a plurality of horizontal parts 223. An auxiliary link 224 is rotatably provided on each horizontal part 223.

Such a construction ensures a predetermined interval between each auxiliary magnet 240 and auxiliary induction coil 250 and neighboring auxiliary magnet and auxiliary induction coil, and provides a stable regular triangular arrangement, thus preventing the auxiliary rotating shaft 220 from being bent to one side or twisted during its rotation, therefore increasing the lifespan of the auxiliary rotating shaft 220.

Further, the auxiliary rotating shaft 222 of the auxiliary conversion unit 220 is bent in one or more directions with respect to the rotating central axis, thus forming a plurality of horizontal parts 223. However, auxiliary links 224, auxiliary rods 230, auxiliary magnets 240 and auxiliary induction coils 250 provided on respective horizontal parts 223 are oriented in one direction.

In detail, the auxiliary rods 230 are parallel to each other and the auxiliary magnets 240 are provided on the auxiliary rods 230 in such a way as to be located at upper and lower positions in a vertical direction, thus reducing the effect of gravity, therefore preventing the auxiliary rods 230 from being bent downwards.

Meanwhile, two or more auxiliary magnets 240 and auxiliary induction coils 250 may be provided on each auxiliary rod 230. A plurality of auxiliary magnets 240 may be provided on each auxiliary rod 230 at regular intervals, and auxiliary induction coils 250 may be provided to correspond to the auxiliary magnets 240.

Such a construction increases the voltage generated by a single rotation. The number of auxiliary magnets and induction coils is not limited to a specific number.

Further, an end of each auxiliary rod 230 branches out into two or more branches. Each branch is provided with the auxiliary magnet 240 and the auxiliary induction coil 250 so as to increase the output of voltage.

Preferably, each branch of the auxiliary rod 230 is parallel to the direction of the linear reciprocating motion, and is provided with a guide 280.

Further, an auxiliary gearbox 290 is provided between the auxiliary impeller 210 and the auxiliary conversion unit 220, and changes the rotating speed of the auxiliary impeller 210, thus increasing a rotating speed transmitted to the auxiliary conversion unit 220.

Through such a construction, when the auxiliary impeller 210 rotates once, the conversion unit 220 is rotated one or more times, so that the linear reciprocating motion of the auxiliary rods 230 is increased, and the amount of induced voltage which is generated is increased.

Meanwhile, as shown in FIG. 16, an auxiliary conversion unit 220′ according to another embodiment of the present invention includes an auxiliary rotating shaft 222′ and an auxiliary pressure member 224′.

The auxiliary rotating shaft 222′ is provided with a plurality of auxiliary cams 223′ along a rotating central axis. Each auxiliary cam 223′ is formed such that distances from a rotating central point to respective portions on an edge gradually vary.

The auxiliary pressure member 224′ presses the auxiliary rod 230′ towards each auxiliary cam 223′. As the auxiliary rod 230′ reciprocates linearly while an end of the auxiliary rod 230′ contacts the outer circumference of each auxiliary cam 223′, induced voltage is generated between the auxiliary magnet 240 and the auxiliary induction coil 250.

Here, an auxiliary roller 232′ is further provided on an end of each auxiliary rod 230′ to reduce frictional force between the auxiliary rod 230′ and the outer circumference of the auxiliary cam 223′, thus allowing the auxiliary rod 230′ to easily reciprocate linearly along the outer circumference of the auxiliary cam 223′.

The auxiliary conversion unit 220′ may substitute for the auxiliary conversion unit 220. All embodiments applied to the auxiliary conversion unit 220 which have been described hereinbefore may be applied to the auxiliary conversion unit 220′.

As described above, the present invention provides an aerogenerator, which converts rotary motion into linear reciprocating motion, and changes induced voltage generated between a magnet and an induction coil by the linear reciprocating motion into an electric current and then stores the electric current.

Further, the present invention provides an aerogenerator, which changes a relatively small amount of induced voltage generated from each of a plurality of magnets and induction coils into electric current and stores the electric current, thus being capable of generating a large amount of electricity as does a conventional aerogenerator, therefore reducing manufacturing cost and maintenance cost because of the reduction in the use of gears and relatively cheap magnets and induction coils. Consequently, the present invention is very useful and effective.

1-17. (canceled)

18. An aerogenerator, comprising:
an impeller rotatable by wind;
a conversion unit which mounts the impeller to a support structure so that the impeller is rotatable, the conversion unit converting rotating motion of the impeller into linear motion;
at least one rod movable in a reciprocating motion by the conversion unit;
a magnet provided on the rod such that the magnet reciprocates with the rod, the magnet having magnetic force;
an induction coil provided outside the reciprocating magnet, and interacting with the magnet to create an induced voltage;
a transform unit for transforming the induced voltage of the induction coil to an electric current; and
an electricity storage unit for storing the electric current of the transform unit.

19. The aerogenerator as set forth in claim 18, wherein the conversion unit comprises:
a rotatable shaft having several bends forming a plurality of horizontal parts each having a central axis parallel to a central rotation axis, the central axis of the horizontal parts rotatable in a circle at a predetermined rotation radius from the central rotation axis; and
a link, a first end of the link being connected to each of the horizontal parts of the rotatable shaft so that the link is rotatable in conjunction with the horizontal part, a second end of the link being connected to the rod so that the link is movable along an extrapolated line coupling the central rotation axis of the rotatable shaft with a central axis of the induction coil.

20. The aerogenerator as set forth in claim 18, wherein the conversion unit comprises:
a rotatable shaft having a plurality of cams along a central rotation axis, each of the cams being formed such that distances from a point on the central rotation axis to respective portions on an edge of the respective cam gradually vary; and
a pressure member capable of reciprocating movement by contact between an end of the rod with an outer circumference of each of the cams, the pressure member capable of storing and exerting elastic force along a direction of reciprocating movement, and pressing the rod towards each of the cams.

21. The aerogenerator as set forth in claim 20, wherein a roller is further provided on the end of the rod to reduce frictional force between the rod and the outer circumference of each of the cams.

22-23. (canceled)

24. The aerogenerator as set forth in claim 18, wherein a plurality of rods, magnets and induction coils are provided along a central rotation axis in rows, the rows of the rods, magnets and induction coils being positioned in one or more directions relative to a central rotation point of the conversion unit.

25. The aerogenerator as set forth in claim 18, wherein at least two magnets are provided on the rod and at least two corresponding induction coils are provided outside the magnets.

26. The aerogenerator as set forth in claim 18, wherein an end of the rod branches out into at least two branches in such a way as to be parallel to a linear motion direction, each of the branches having on an end thereof the magnet, with the induction coil outside the magnet.

27. The aerogenerator as set forth in claim 18, wherein a guide is provided outside the rod to guide a linear reciprocating motion.

28. The aerogenerator as set forth in claim 18, wherein a gearbox is provided between the impeller and the conversion unit to change a rotation speed of the impeller.

29. The aerogenerator as set forth in claim 18, further comprising:
an auxiliary impeller provided on a side opposite to the support structure to which the impeller is mounted;
an auxiliary conversion unit which mounts the auxiliary impeller to a support structure so that the auxiliary impeller is rotatable, the auxiliary conversion unit converting rotating motion of the auxiliary impeller into linear motion;
at least one auxiliary rod movable in a reciprocating motion by the auxiliary conversion unit;
an auxiliary magnet provided on the auxiliary rod and having magnetic force;
an auxiliary induction coil provided outside the auxiliary magnet, and interacting with the auxiliary magnet to create an induced voltage;
an auxiliary transform unit for transforming the induced voltage of the auxiliary induction coil to an electric current; and
an auxiliary electricity storage unit for storing the electric current of the auxiliary transform unit.

30. The aerogenerator as set forth in claim 29, wherein the auxiliary impeller is placed on the same axis as the central rotation axis of the impeller, a radius of an arc formed by rotating the auxiliary impeller being equal to 35 to 45% of a radius of an arc formed by rotating the impeller.

31. The aerogenerator as set forth in claim 29, wherein the auxiliary conversion unit comprises:
an auxiliary rotatable shaft having several bends forming a plurality of horizontal parts each having a central axis parallel to a central rotation axis, the central axis of the horizontal parts rotatable in a circle at a predetermined rotation radius from the central rotation axis; and
an auxiliary link, a first end of the auxiliary link being connected to each of the horizontal parts of the auxiliary rotatable shaft so that the auxiliary link is rotatable in conjunction with the horizontal part, a second end of the auxiliary link being connected to the auxiliary rod so that the auxiliary link is movable along an extrapolated line coupling the central rotation axis of the auxiliary rotatable shaft with a central axis of the auxiliary induction coil.

32. The aerogenerator as set forth in claim 29, wherein the auxiliary conversion unit comprises:
a auxiliary rotatable shaft having a plurality of auxiliary cams along a central rotation axis, each of the auxiliary cams being formed such that distances from a point on the central rotation axis to respective portions on an edge of the respective auxiliary cam gradually vary; and
a auxiliary pressure member capable of reciprocating movement by contact between an end of the auxiliary rod with an outer circumference of each of the auxiliary cams, the auxiliary pressure member capable of storing and exerting elastic force along a direction of reciprocating movement, and pressing the auxiliary rod towards each of the auxiliary cams.

33. (canceled)

34. The aerogenerator as set forth in claim 29, wherein an auxiliary gearbox is provided between the auxiliary impeller and the auxiliary conversion unit to change a rotation speed of the auxiliary impeller.
